(19) United States
(12) Patent Application Publication
(10) Pub. No.: US 2007/0118800 A1
(43) Pub. Date: May 24, 2007

(54) Systems and methods for dynamically integrated capture, collection, authoring, presentation and production of digital content

(76) Inventors: Michael R. Moore, Folsom, CA (US); Daniel A. Kaye, Folsom, CA (US); Kenneth A. Turcotte, Folsom, CA (US); Randy J. Jongens, Folsom, CA (US); Michael D. Wang-Helmke, Carmichael, CA (US); Peter A. Tjeerdsma, Fair Oaks, CA (US); Christopher H. Davey, Sacramento, CA (US)

Correspondence Address: CARR & FERRELL LLP, 2200 GENG ROAD, PALO ALTO, CA, 94303, US

(21) Appl. No.: 11/517,940

(22) Filed: Sep. 7, 2006

Related U.S. Application Data
(60) Provisional application No. 60/714,976, filed on Sep. 7, 2005.

(51) Int. Cl. G06F 17/00; H04N 5/44

(52) U.S. Cl. 715/730; 715/500.1; 715/838; 715/716

(57) ABSTRACT

Systems and methods for dynamically integrated capture, collection, authoring, presentation and production of digital content are provided. According to one embodiment, a user interface automatically captures and collects digital content as the digital content is viewed by a user. The user interface includes features for the user to author some or all of the collected digital content. A further embodiment of the user interface formats the digital content in the presentation band for previewing in a variety of production formats, including as a web page, webshow, digital video disk “DVD”) and/or printbook. The user interface then allows the user to save the presentation and/or produce the presentation at a production facility.

### CROSS-REFERENCE TO RELATED APPLICATIONS

The present application claims the benefit and priority of U.S. Provisional Patent Application Ser. No. 60/714,976 filed on Sep. 7, 2005 for “Dynamic Content Capture, Collection, Authoring, Presentation and Production,” which is herein incorporated by reference; the present application also incorporates by reference U.S. patent application Ser. No. 11/437,207 filed on May 19, 2006 for “Systems and Methods for Web Server Based Media Production,” and U.S. patent application Ser. No. __/______ Attorney Docket # PA3410US filed on Sep. 7, 2006 for “Systems and Methods for Organizing Media Based on Associated Metadata.”

### BACKGROUND OF THE INVENTION

1. Field of the Invention

The present invention relates generally to digital content tools, and more particularly to systems and methods for dynamically integrated capture, collection, authoring, presentation and production of digital content.

2. Description of Related Art

Existing tools for organizing and presenting digital content such as Windows™ or Maclntosh™ file system tools, browser history tools, and favorites/bookmark tools, are typically complex and require a significant level of user expertise. Tools for authoring final media output such as slideshows, digital video disks (“DVDs”), or print page layouts require a high degree of artistic talent to produce aesthetically pleasing results. Additionally, most tools work with a limited variety of data formats and are often limited to working with data formats established by the manufacturer or developer of the particular tool. Finally, few tools (if any) encompass a single user interface that works across the entire process of digital content capture, collection, authoring, presentation and production. There is therefore a need for systems and methods for dynamically integrated capture, collection, authoring, presentation and production of digital content.

### SUMMARY OF THE INVENTION

Systems and methods for dynamically integrated capture, collection, authoring, presentation and production of digital content are provided. An exemplary method comprises capturing one or more items of digital content with a user interface, collecting the captured one or more items of digital content with the user interface, authoring the collected one or more items of digital content with the user interface, and presenting the authored one or more items of digital content with the user interface. A further method comprises producing one or more items of presented digital content with the user interface.

An exemplary system for dynamically integrated capture, collection, authoring, presentation and production of digital content comprises a user interface configured with a capture component to automatically capture digital content, a collection component to automatically collect the captured digital content, an authoring component to author the collected digital content, and a presentation component to present the authored digital content. Another system further comprises the user interface configured with a production component to produce the presented digital content.

### BRIEF DESCRIPTION OF THE DRAWINGS

FIG. 1 is a block diagram of an exemplary user interface application for dynamically integrated capture, collection, authoring, presentation and production of digital content;

FIG. 2 is an exemplary screen shot of a user interface for dynamically integrated capture, collection, authoring, presentation and production of digital content, showing the capture and collection features;

FIG. 3 is an exemplary screen shot of a user interface for dynamically integrated capture, collection, authoring, presentation and production of digital content, showing the authoring and presentation features;

FIG. 4 is an exemplary screen shot of a user interface for dynamically integrated capture, collection, authoring, presentation and production of digital content, showing the presentation and production features; and

FIG. 5 is a flow diagram of an exemplary process for dynamically integrated capture, collection, authoring, presentation and production of digital content.

### DETAILED DESCRIPTION

Systems and methods for dynamically integrated capture, collection, authoring, presentation and production of digital content are provided. According to one embodiment, a web-browser plug-in application in the form of a user interface automatically captures and collects digital content as the digital content is viewed by a user. The user interface includes features for the user to author some or all of the collected digital content. A further embodiment of the user interface automatically formats the digital content for previewing in a variety of production formats, including as a web page, webshow, DVD and/or printbook. The user interface then allows the user to save the presentation and/or to produce the presentation at a production facility.

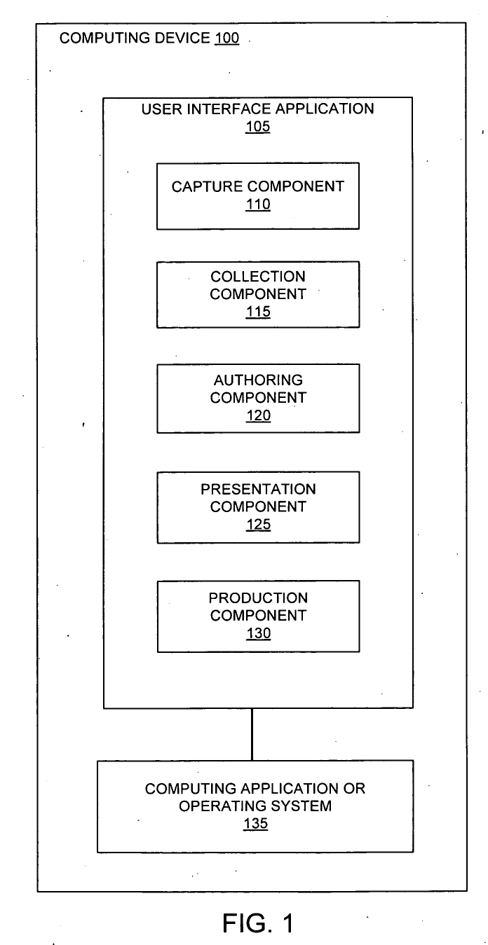

FIG. 1 is a block diagram of an exemplary user interface application 105 for dynamically integrated capture, collection, authoring, presentation and production of digital content. According to one embodiment, the user interface application 105 resides on a computing device 100. The computing device 100 shown in FIG. 1 has a computing application or operating system 135, with the user interface application 105 associated as a plug-in application. In an alternative embodiment, the user interface application 105 may operate as a standalone application either on the computing device 100 or on a network server. Additionally, the user interface application 105 may be implemented using dynamic HTML techniques, or as an Active-X control or other type of software application extension.

In one embodiment, the user interface application 165 comprises a capture component 110, a collection component 115, an authoring component 120, a presentation component 125 and a production component 130. The capture component 110 is configured to automatically capture digital content in real time while a user is viewing and/or listening to the digital content on a computing device 100. Digital content may include audio, video, audiovisual, pictorial, photographic, image forms, text files, web pages, and all variations and combinations thereof. A collection component 115 automatically collects captured digital content as an overlapping display of icons or thumbnails in a collection band on the user interface. In further embodiments, the collection component 115 allows the user to save collected digital content in one or more folders that reside on the computing device 100 or on a network server.

An authoring component 120 on the user interface application 105 allows a user to select specific parts of collected digital content for presentation, and may include additional functions if desired. For example, the authoring component 120 may allow a user to select a specific image or text section from a single page of collected digital content to form part of a presentation. The authoring component 120 may also allow the user to add imported digital content to a page of collected digital content for presentation.

User interface application 105 includes a presentation component 125 which allows a user to view authored digital content as icons or thumbnails in a presentation band on the user interface 105. Presentation component 125 may also format the digital content in the presentation band for previewing by the user in a variety of production formats, including as a web page, webshow, DVD and/or printbook. The presentation component 125 may also automatically add aesthetic embellishments to the digital content based on the selected production format. The user may preview the production formatted digital content in a window adjacent to the user interface. Additionally, the presentation component 125 allows the user to save the production formatted digital content in one or more folders that reside on the computing device 100 or on a network server.

A production component 130 is included with the user interface application 105 for allowing a user to seamlessly produce production formatted digital content at a production facility. For example, the user interface may include “print,” “buy,” or “ship,” printbook or DVD selections.

Although the exemplary user interface application 105 is described as being comprised of various components (the capture component 110, collection component 115, authoring component 120, presentation component 125, and production component 130), fewer or more components may comprise the user interface application and still fall within the scope of various embodiments.

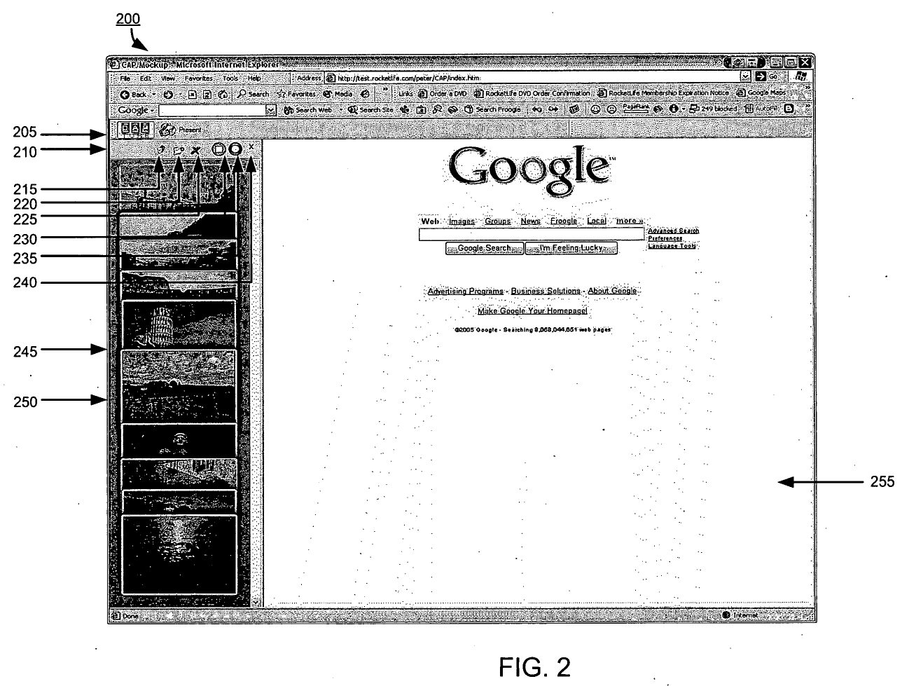

Referring now to FIG. 2, an exemplary screen shot 200 of a user interface for dynamically integrated capture, collection, authoring, presentation and production of digital content is shown, showing the capture and collection features of various embodiments. The exemplary screen shot 200 includes a capture selection 205, and capture controls selections 210. The capture controls selections include a parent folder selection 215, a new folder selection 220, delete selection 225, stop capture selection 230, start capture selection 235, and close capture controls selection 240. Also shown in FIG. 2 is a collection band 245 that includes one or more thumbnails or icons 250, and a window 255.

In the exemplary screen shot 200, when a user activates capture selection 205, capture controls selections 210 and collection band 245 automatically appear next to or near window 255. User activation of start capture selection 235 results in capture component 110 (FIG. 1) automatically capturing a copy of each screen of digital content viewed by the user in window 255. A copy of each screen of digital content viewed by the user is automatically collected as a thumbnail or icon 250 by collection component 115 (FIG. 1). The collected thumbnails 250 are displayed in collection band 245. Collection band 245 is a scrollable collection of thumbnails 250 appearing in a chosen order, for example, the order they are captured or viewed by the user. It will readily be appreciated by one of ordinary skill in the art that other types of files may be imported into collection band 245 and represented by thumbnails, icons or other images and remain with the scope of embodiments claimed herein.

According to one embodiment, thumbnails 250 in collection band 245 are displayed in an overlapping fashion, similar to the way index cards may be maintained in an index card file. The amount or degree of overlap may be determined as a function of the number of thumbnails 250 in the collection band 245. For example, a large number of thumbnails 250 in the collection band 245 may be displayed as significantly overlapping, where only a small part of each thumbnail 250 is displayed. Each particular thumbnail 250 in collection band 245 may be animated in order to expand or spread it relative to the other thumbnails for easy user viewing and/or recognition when the user moves a mouse or other cursor means over the particular thumbnail 250. The particular thumbnail 250 may also be displayed in a larger fashion in window 255.

In an exemplary user interface, when a user right clicks on a thumbnail 250 in collection band 245, a pop-up menu will be displayed that offers selections such as display cached item, display current item, delete item, and/or new folder. Alternatively, the thumbnails 250 may be saved in various folders by activating parent folder selection 215, and/or new folder selection 220. When activated, new folder selection 220 automatically inserts a new folder in the collection band 245. When a user double clicks on the folder in the collection band 245, the user will automatically navigate down a hierarchy of folders. Conversely, when the user double clicks on parent folder selection 215, the user will automatically navigate up the hierarchy of folders. Additionally, when a user selects a particular folder of thumbnails 250, the thumbnails 250 may be displayed as a set of thumbnails 250 in collection band 245.

A user of an exemplary user interface may elect to delete a thumbnail 250 from a collection band 245 by clicking on the thumbnail 250 and activating delete selection 225. Additionally, the user may wish to terminate capture of digital content and the collection of corresponding thumbnails 250 in collection band 245 by activating stop capture selection 230. A user may activate start capture selection 235 a second time or may activate close capture controls selections 240 to terminate capture of digital content and to close collection band 245.

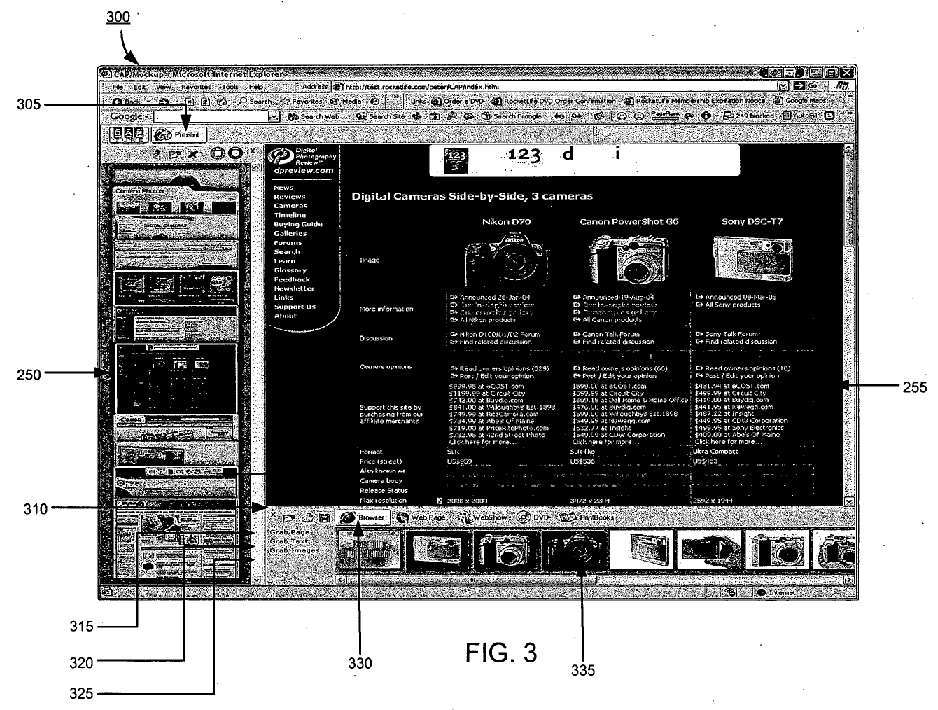

Referring now to FIG. 3, an exemplary screen shot 300 of a user interface for dynamically integrated capture, collection, authoring, presentation and production of digital content is shown, showing the authoring and presentation features of certain embodiments. The exemplary screen shot 300 includes present selection 305, highlighted thumbnail 250, presentation band 310, grab page selection 315, grab text selection 320, grab images selection 325, browser selection 330, digital content for presentation 335 (in presentation band 310), and window 255.

According to one embodiment, when a user activates present selection 305, presentation component 125 (FIG. 1) triggers display of presentation band 310. When the user activates browser selection 330 on the presentation band 310, digital content corresponding to a highlighted thumbnail 250 is displayed in window 255. Additionally, activation of browser selection 330 triggers authoring component 120 (FIG. 1) to display grab page selection 315, grab text selection 320, and grab images selection 325.

Grab page selection 315 allows a user to select an entire page of digital content as displayed in widow 255. The entire page of digital content automatically may appear as digital content for presentation 335 in presentation band 310 in the order it was selected, for example, or can be dragged by the user to another location in the presentation band 310. Grab text selection 320 allows a user to select specific text or parts of text from a page of digital content displayed in window 255. The selected text automatically appears as digital content for presentation 335 in presentation band 310. Grab images selection 325 allows a user to select a specific image or parts of an image from a page of digital content displayed in window 255. The selected image or images automatically appears as digital content for presentation 335 in presentation band 310. In a further embodiment, authoring component 120 may display additional selections in presentation band 310, such as add music, for adding music to a presentation.

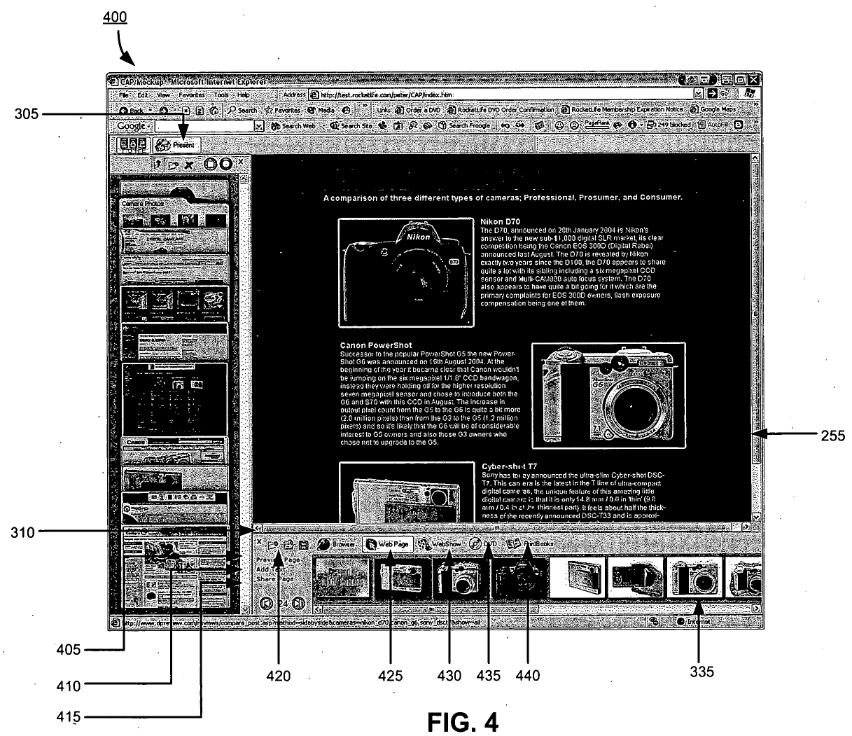

Referring now to FIG. 4, an exemplary screen shot 400 of a user interface for dynamically integrated capture, collection, authoring, presentation and production of digital content is shown, showing the presentation and production features of some embodiments. The exemplary screen shot 400 includes present selection 305, presentation band 310, preview page selection 405, add text selection 410, share page selection 415, save selection 420, web page selection 425, webshow selection 430, DVD selection 435, printbook selection 440, digital content for presentation 335, and window 255.

According to one embodiment, when a user activates present selection 305, presentation component 125 (FIG. 1) triggers display of presentation band 310. When the user activates web page selection 425 on the presentation band 310, the presentation component 125 formats the digital content in the presentation band 310 for previewing in a web page production format, as shown in window 255. When the user activates webshow selection 430, the presentation component 125 formats the digital content for previewing in a webshow production format, such as a sequence of animated slides, where the user may stop, pause, fast forward, and/or reverse the webshow. The user may also be given the option of forwarding the webshow to a network server, allowing others to preview the webshow. Similarly, when the user activates DVD selection 435 or printbook selection 440, the presentation component 125 will format the digital content in the presentation band 310 for previewing in a DVD production format or a printbook production format.

Activation of web page selection 425 in one embodiment triggers presentation component 125 (FIG. 1) to display preview page selection 405 and share page selection 415. Preview page selection 405 allows a user to preview a highlighted or selected item of digital content for presentation 335 as a page of digital content in widow 255. Share page selection 415 allows a user to email a particular page of digital content as displayed in window 255 to another user.

Save selection 420 allows a user to save a presentation to a folder on a computing device 100 (FIG. 1) or on a network server. Alternatively, or in addition to saving a presentation on the computing device 100 or on the network server, production component 130 (FIG. 1) may be configured to allow the user to produce production formatted digital content at a production facility. For example, the user interface may include “print,” “buy,” or “ship,” printbook or DVD selections, resulting in the production formatted digital content being delivered to the user.

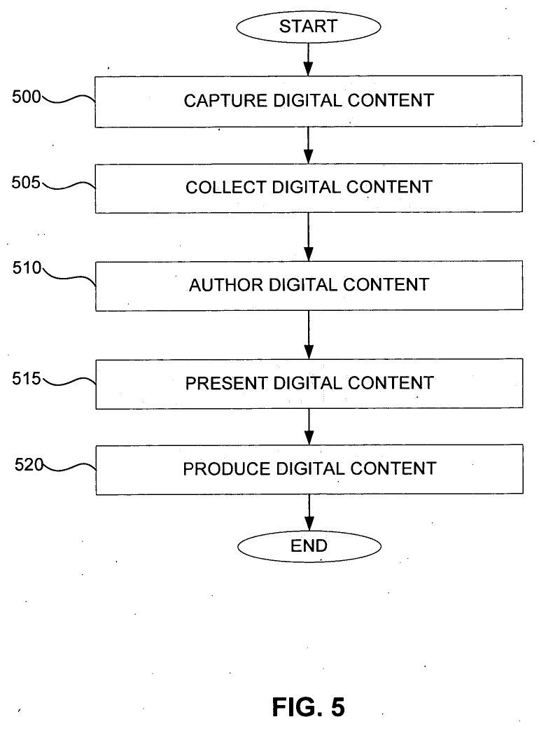

Referring now to FIG. 5, a flow diagram of an exemplary process for dynamically integrated capture, collection, authoring, presentation and production of digital content is shown.

At step 500, digital content is captured. According to one embodiment, digital content is captured in real time while a user is viewing the digital content on a computing device 100 (FIG. 1).

At step 505, captured digital content is collected. In an exemplary embodiment, captured digital content is collected as thumbnails or icons in a collection band 245 (FIG. 2).

At step 510, collected digital content is authored. According to one embodiment, specific images or text sections on a single page of collected digital content are selected by a user of a user interface to form part of a presentation.

At step 515, authored digital content is presented. In an exemplary embodiment, a presentation component 125 (FIG. 1) formats authored digital content in a production format for previewing by a user.

At step 520, the presented digital content is produced. According to one embodiment, a production component 130 (FIG. 1) is configured to allow a user of a user interface to produce production formatted digital content at a production facility.

While various embodiments have been described above, it should be understood that they have been presented by way of example only, and not limitation. Thus, the breadth and scope of a preferred embodiment should not be limited by any of the above-described exemplary embodiments.

What is claimed is:

1. A method for dynamically integrating digital content comprising:
providing a computing device configured with a user interface capable of accessing a plurality of digital content in a wide variety of formats;
capturing the plurality of digital content with the user interface;
collecting the captured plurality of digital content with the user interface;
authoring the collected plurality of digital content with the user interface; and
presenting the authored plurality of digital content with the user interface.

2. The method of claim 1, further comprising producing the plurality of presented digital content with the user interface.

3. The method of claim 1, wherein the captured plurality of digital content is collected in a collection band on the user interface.

4. The method of claim 1, wherein the collected plurality of digital content is authored by a user of the user interface adding text to the plurality of collected digital content.

5. The method of claim 3, wherein the captured plurality of digital content is collected as thumbnails in the collection band.

6. The method of claim 5, wherein the thumbnails in the collection band are overlapping.

7. The method of claim 1, wherein the collected digital content is authored by a user of the user interface adding text to the collected digital content.

8. The method of claim 1, wherein the collected digital content is authored by a user of the user interface adding music to the collected digital content.

9. A system for dynamically integrating digital content comprising:
a computing device configured with a user interface capable of accessing digital content in a wide variety of formats;
the user interface further configured with a capture component to capture digital content;
the user interface further configured with a collection component to collect the captured digital content;
the user interface further configured with an authoring component to author the collected digital content; and
the user interface further configured with a presentation component to present the authored digital content.

10. The system of claim 9, further comprising the user interface further configured with a production component to produce the presented digital content.

11. The system of claim 9, wherein the captured digital content is collected in a collection band on the user interface.

12. The system of claim 11, wherein the captured digital content is collected as thumbnails in the collection band.

13. The system of claim 12, wherein the thumbnails in the collection band are overlapping.

14. The system of claim 9, wherein the collected digital content is authored by a user of the user interface adding test to the collected digital content.

15. The system of claim 9, wherein the collected digital content is authored by a user of the user interface adding music to the collected digital content.

16. The system of claim 10, wherein the presented digital content is produced in a DVD production format.

17. The system of claim 10, wherein the presented digital content is produced in a printbook production format.

18. A computer readable medium having embodied thereon a program, the program being executable by a processor for performing a method for dynamically integrating digital content, the method comprising:
providing a computing device configured with a user interface capable of accessing a plurality of digital content in a wide variety of formats;
capturing the plurality of digital content with the user interface;
collecting the captured plurality of digital content with the user interface;
authoring the collected plurality of the digital content with the user interface;
presenting the authored plurality of digital content with the user interface; and
producing the plurality of presented digital content with the user interface.
